(19) United States
(12) Patent Application Publication
(10) Pub. No.: US 2021/0180702 A1
(43) Pub. Date: Jun. 17, 2021

(54) ATTACHABLE FLOW RATE CONTROLLING DEVICE

(71) Applicant: CHIH-HSIANG LEE, Taoyuan City (TW)

(72) Inventor: CHIH-HSIANG LEE, Taoyuan City (TW)

(21) Appl. No.: 17/028,791

(22) Filed: Sep. 22, 2020

(30) Foreign Application Priority Data
Dec. 11, 2019 (TW) 108216439

(51) Int. Cl. F16K 5/04; F16K 31/60

(52) U.S. Cl. CPC F16K 5/0492; A01K 63/006; F16K 31/60; F16K 5/0442

(57) ABSTRACT

An attachable flow rate controlling device comprising a flow rate control unit and a fastener is disclosed. The flow rate control unit comprises a chamber and an adjustable valve. The adjustable valve is configured to control the rate of water flow by converting the adjustable valve to turn on/off, so that a fish keeper is able to control the rate of water flow from an aquarium. Additionally, the flow rate control unit is fixed securely or pasted around an opening of a bucket or on a flat surface by the fastener. As such, the fish keeper can change the water in the aquarium and control the flow rate of the water from the aquarium. The attachable flow rate controlling device is controlled by rotating the adjustable valve hence enabling the fish keeper to use the attachable flow rate controlling device without repeatedly refilling the siphon hose with water.

### BACKGROUND OF THE INVENTION

### 1. Field of the Invention

The present invention relates to the technology field of aquarium and fishkeeping, and more particularly to an attachable flow rate controlling device.

### 2. Description of the Prior Art

With advancement of science and technology and enhancement of the quality of life, people are paying more and more attention to personal recreation to relieve them from the pressures of life. For example, pets have become highly popular, and have been found to be effective in this regard. Research and statistical data show that more than one half of the world's population have at least one pet. Fish rank third place among most popular pets, behind dogs which rank number one and cats that rank number two. On the other hand, statistical data also indicate that the global market of aquarium and fishkeeping account for billions of dollars of revenue. The United States is known as the largest market of aquarium and fishkeeping in the world. Therefore, providing an outstanding device for people to conveniently keep fish in a home aquarium is an important issue.

Management of water quality is basic and most important for fish keeping. As explained in more detail below, aquarium water becomes dirty because of excess feed and feces that accumulate causing the fish to suffer from disease if dirty water is not changed. More seriously, the unhealthy and dirty water may cause fish to die. FIG. 1 illustrates a schematic stereo diagram of a conventional siphon device. It is worth noting that, FIG. 1 depicts a current method to change water in an aquarium. In which, a cylindrical tube 12′ is submerged in an aquarium, and a siphon hose 11′ is connected to the cylindrical tube 12′ by a port 111′. Moreover, the other port 112′ of the siphon hose 11′ is placed inside a bucket 2′ or in a sink. As such, water in the aquarium is made to flow through the siphon hose 11′ and eventually ends inside the bucket 2′ or a sink by a siphoning action. However, a conventional siphon device 1′ has shortcomings and drawbacks in practical application. The shortcomings are summarized in the following paragraphs.

(1) Most aquarium fish fail to survive in dirty and unhealthy water. On the other hand, they thrive in clean and healthy water. Therefore, from FIG. 1, it is clear that using conventional siphon device 1′, it is very difficult for a fish keeper to control the rate of water flow in the siphon device 1′. Besides, when the bucket 2′ is full of water; flow needs to be stopped and the bucket 2′ emptied; however water from the other port 112′ of the siphon hose 11′ will spill on the floor without a device to stop the flow or a bucket 2′ to catch it. Furthermore, to continue the process of water change, the other port 112′ of the siphon hose 11′ needs to be repositioned in bucket 2′ and siphoning action re-initiated to resume flow and the process of changing water. The above makes it clear that water changing using the conventional siphon device 1′ is time-consuming and bothersome.

(2) When a fish keeper changes the water of the aquarium, he has to hold both the cylindrical tube 12′ and the other port 112′ of the siphon device 1′ to prevent water from spilling due to the fact that the other port 112′ is not fastened to the bucket. It is clear that conventional siphon device 1′ can be improved.

Since conventional siphon device 1′ has shortcomings and drawbacks in practical application, inventors of the present application have gone through great efforts and research to provide an attachable flow rate controlling device that facilitates aquarium water changing.

### SUMMARY OF THE INVENTION

The primary objective of the present invention is to provide an attachable flow rate controlling device, comprising: a flow rate control unit and a fastener. Wherein, the flow rate control unit comprises a chamber and an adjustable valve. In the present invention, the adjustable valve is configured to control the rate of water flow by rotating the adjustable valve to turn on/off, such that a fish keeper is able to control the rate of water flow from an aquarium. Furthermore, the flow rate control unit of the present invention is attached firmly to the lip of the bucket opening. By such an arrangement, a fish-keeper conveniently and easily executes a water change and controls the rate at which water flows from the aquarium.

For achieving the primary objective of the present invention, the inventor of the present invention provides an attachable flow rate controlling device, comprising:

a flow rate control unit, being connected to a siphon hose, wherein the flow rate control unit comprises:
a chamber, having a water inlet, a water outlet, and an adjustable hole; an amount of water flows through the water inlet from the siphon hose, and flows away from the water outlet;
an adjustable valve, a portion thereof being inserted in the chamber to control the rate of water flow;
   a fastener, being connected to the flow rate control unit, and being configured to fix the flow rate control unit around an opening of a bucket or on a flat surface.

### BRIEF DESCRIPTION OF THE DRAWINGS

The invention as well as a preferred mode of use and advantages thereof is best understood by referring to the following detailed description of an illustrative embodiment in conjunction with the accompanying drawings, wherein:

FIG. 1 shows a schematic stereo diagram of a conventional siphon device;

FIG. 2 shows a first stereo diagram of an attachable flow rate controlling device according to the present invention;

FIG. 3 shows a schematic stereo diagram of the attachable flow rate controlling device;

FIG. 4 shows an operating diagram of the attachable flow rate controlling device;

FIG. 5 shows a second stereo diagram of the attachable flow rate controlling device;

FIG. 6 shows a first connected framework diagram of the attachable flow rate controlling device, a siphon hose, and a water hose; and

FIG. 7 shows a second connected framework diagram of the attachable flow rate controlling device, the siphon hose, and the water hose.

### DETAILED DESCRIPTION OF THE PREFERRED EMBODIMENTS

To more clearly describe an attachable flow rate controlling device, embodiments of the present invention will be described in detail with reference to the attached drawings hereinafter.

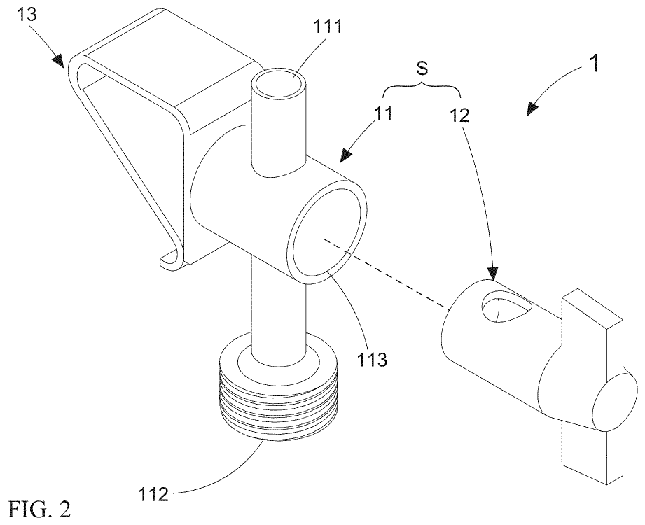

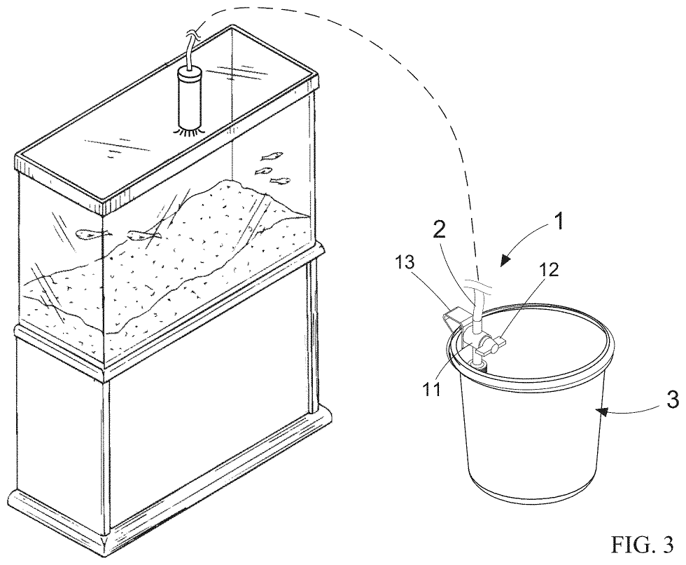

With reference to FIG. 2, there is provided a first stereo diagram of an attachable flow rate controlling device according to the present invention. Please simultaneously refer to FIG. 3, which shows a schematic stereo diagram of the attachable flow rate controlling device. As shown in FIG. 2, the attachable flow rate controlling device of the present invention comprises: a flow rate control unit S and a fastener 13. The flow rate control unit S is connected to a siphon hose 2, and comprises: a chamber 11 and an adjustable valve 12. The chamber 11 having a water inlet 111, a water outlet 112, an adjustable hole 113, wherein a portion of the adjustable valve 12 is inserted in the chamber 11. Such an arrangement can allow water to flow through the water inlet 111 from the siphon hose 2 and flow away from the water outlet 112. Note that, the fastener 13 is connected to the flow rate control unit S, and is configured to attach the flow rate control unit S around an opening of a bucket 3 or on a flat surface.

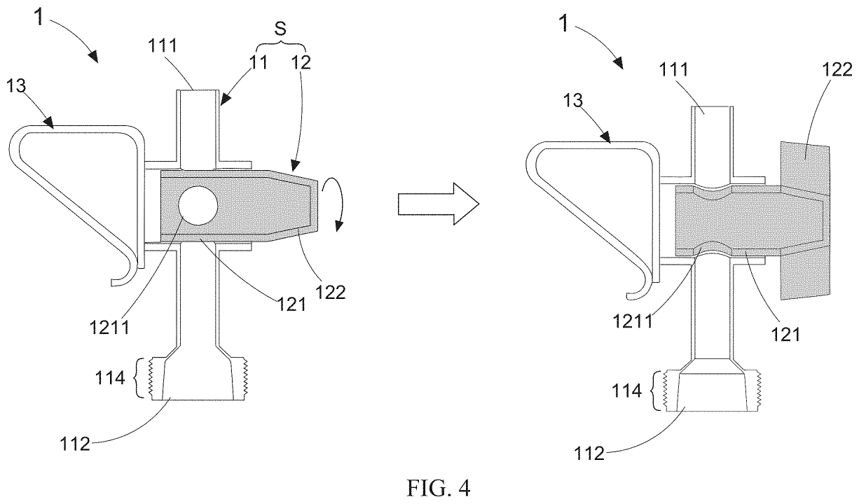

Continue to refer to FIG. 2 and FIG. 3, additionally refer to FIG. 4, which shows an operating diagram of the attachable flow rate controlling device. The adjustable valve 12 comprises: an adjustable portion 121 and a rotatable portion 122, wherein the rotatable portion 122 is connected to the adjustable portion 121. As shown in FIG. 4, the chamber 11 encloses the adjustable portion 121, and the adjustable portion 121 forms a through hole 1211 thereon. When the adjustable section 121 is aligned with the water inlet 111 and the water outlet 112 water can flow through the hole 1211. Based on an external twisting force, the rotatable portion 122 rotates and drives the adjustable portion 121 to rotate to a first state. In the case of the first state of the adjustable portion 121, the through hole 1211 is connected to the water inlet 111 and the water outlet 112. Moreover, based on the other external force, the rotatable portion 122 rotates and drives the adjustable portion 121 to rotate and be changed from the first state to a second state. In the case of the second state of the adjustable portion 121, the adjustable portion 121 blocks a path between the water inlet 111 and the water outlet 112, such that the amount of water is unable to flow away from the water outlet 112. It is worth noting that, according to the specific design of the present invention, a fish keeper is able through a cross-sectional pathway of the water flow pathway of the flow rate control unit S to adjust the flow rate of the water. For instance, when the bucket 3 is full of water, the fish keeper can stop the flow of water by rotating the adjustable valve 12. Then, after pouring water out from bucket 3, the fish keeper only needs to rotate the adjustable valve 12 in the opposite direction to allow water to continue flowing. In other words, using the attachable flow rate controlling device 1 of the present invention, the fish keeper is capable of changing the water of the aquarium without re-initiating siphoning action to put water into the siphon hose 2.

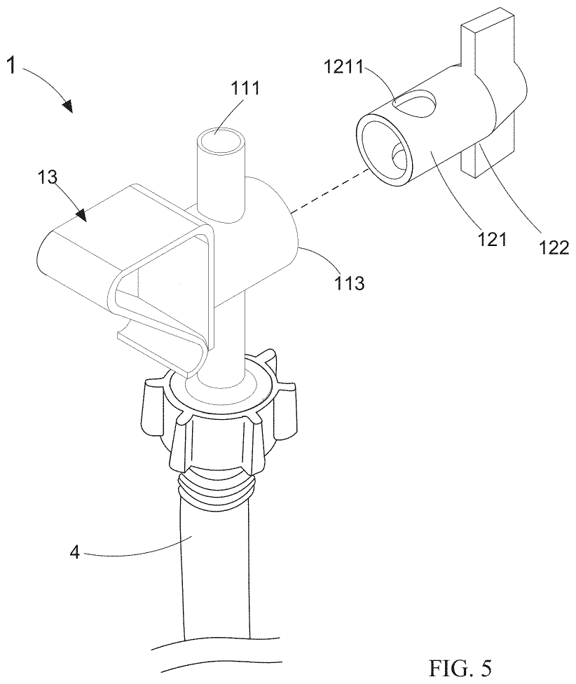

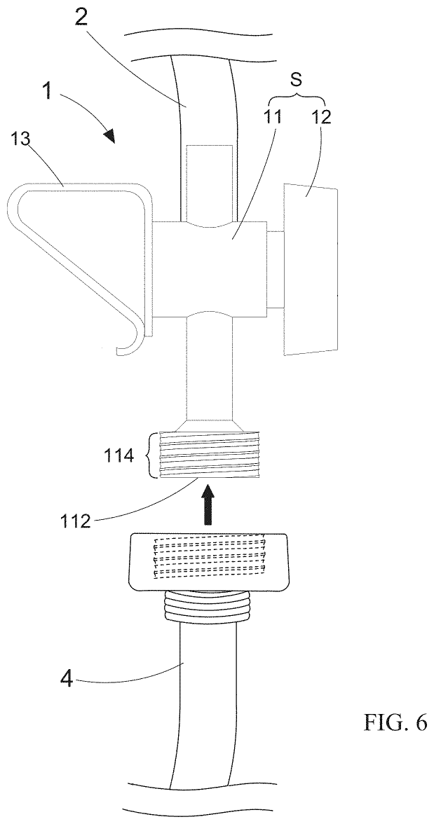

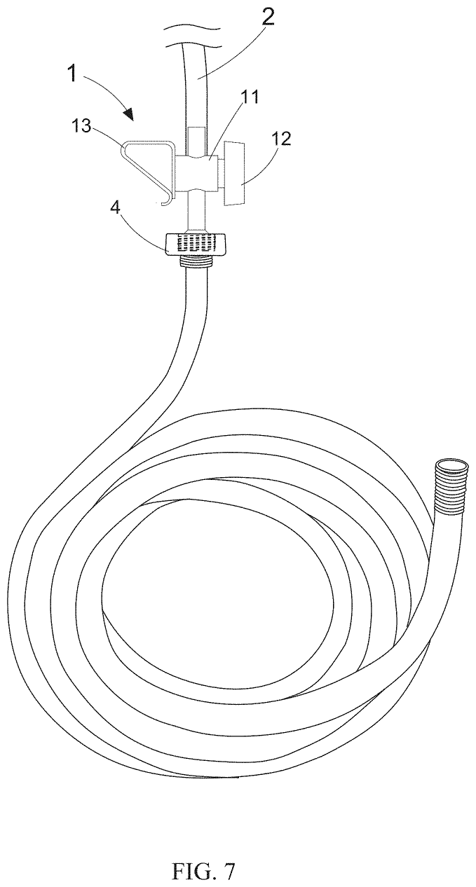

Building on the above descriptions, and please refer to FIG. 5, which shows a second stereo diagram of the attachable flow rate controlling device. It is worth noting that the fastener 13 is a clamp unit or an adhesive unit. Moreover, in practical application, the fish-keeper attaches the fastener 13 of the attachable flow rate control device 1 onto the lip of the opening of bucket 3 or a flat surface according to the situation easily guiding the water of the aquarium into the bucket 3 or a sink. For instance, the fastener 13 is a clamp unit attached to the opening of bucket 3 when the fish keeper guides the water into the bucket 3. Or the fastener 13 is an adhesive unit to be fixed on a wall or surface of a sink when the fish keeper guides the water of the aquarium into a sink. It is worth noting that, there is a hand siphon pump connected between the water inlet 111 and the siphon hose 2 to speed up filling siphon hose 2 with water. It needs to be explained that the clamp unit is an adjustable clamping unit for adapting the clamp to different thicknesses of buckets. Furthermore, the clamp unit further comprises two slip-resistant portions, wherein the two slip-resistant portions are respectively disposed on two surfaces of the clamp unit to enhance the frictional force between the clamp unit and the bucket. Please simultaneously refer to FIG. 6 and FIG. 7, which show a first connected framework diagram and a second connected framework diagram of the attachable flow rate controlling device, a siphon hose, and a water hose. As shown in FIG. 6, the chamber 11 of the present invention further comprises a threaded structure 114, wherein the threaded structure 114 is situated on the chamber 11 above water outlet 112, and the threaded structure 114 is configured for connecting to a water hose 4.

Therefore, through above descriptions, the attachable flow rate controlling device of the present invention has been described completely and clearly; in summary, the present invention has these advantages:

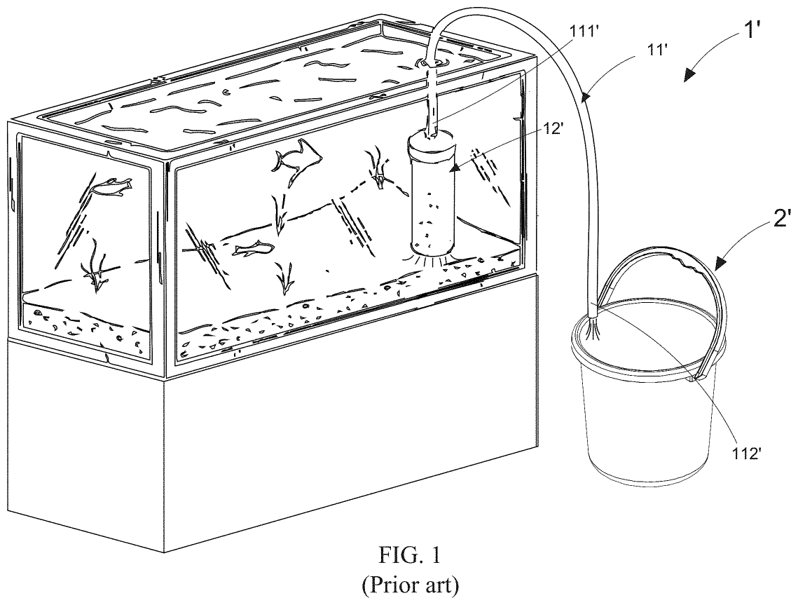

(1) Differing from conventional siphon device 1′ shown in FIG. 1 being unable to control flow rate of a water from an aquarium, the present invention discloses an attachable flow rate controlling device 1 capable of controlling the rate of water flow by design thereof and prevent the sand from being sucked up from the aquarium. The attachable flow rate controlling device 1 comprises: a flow rate control unit S and a fastener 13. Moreover, the flow rate control unit S comprises a chamber 11 and an adjustable valve 12. When a fish keeper changes the water of the aquarium, he is easily able to control the rate of water flow using adjustable valve 12. More particularly, when the fish keeper changes the water of the aquarium, it is easy to control the rate of water flow using the attachable flow rate controlling device 1 of the present invention.

The above description is made on embodiments of the present invention. However, the embodiments are not intended to limit scope of the present invention, and all equivalent implementations or alterations within the spirit of the present invention still fall within the scope of the present invention.

What is claimed is:

1. An attachable flow rate controlling device, comprising:
a flow rate control unit, being connected to a siphon hose, wherein the flow rate control unit comprises:
a chamber, having a water inlet, a water outlet, and an adjustable hole; an amount of water flows through the water inlet from the siphon hose, and flows away from the water outlet;
an adjustable valve, a portion thereof being inserted in the chamber to control the rate of water flow;
a fastener, being connected to the flow rate control unit, and being configured to fix the flow rate control unit around an opening of a bucket or on a flat surface.

2. The attachable flow rate controlling device of claim 1, wherein the adjustable valve comprises:
an adjustable portion, having a through hole; the adjustable portion is confined by the chamber;
a rotatable portion, being connected to the adjustable portion;
wherein the rotatable portion rotates and drives the adjustable portion to rotate to a first state based on an external force;
wherein in the case of the first state of the adjustable portion, the through hole is connected to the water outlet and the water inlet, such that water flows away from the water outlet;
wherein the rotatable portion rotates and drives the adjustable portion to rotate and be changed from the first state to a second state based on the other external force;
wherein in the case of the second state of the adjustable portion, the rotatable portion blocks a pathway between the water outlet and the water inlet, so that water is unable to flow away from the water outlet.

3. The attachable flow rate controlling device of claim 1, wherein the fastener is a clamp unit or an adhesive unit.

4. The attachable flow rate controlling device of claim 3, wherein the clamp unit is an adjustable clamping unit.

5. The attachable flow rate controlling device of claim 2, wherein a hand siphon pump is connected between the water inlet and the siphon hose.

6. The attachable flow rate controlling device of claim 3, wherein the clamp unit further comprising:
two slip-resistant portions, being respectively deployed on two surfaces of the clamp unit.

7. The attachable flow rate controlling device of claim 1, wherein the chamber further comprising:
a threaded structure, being deployed on the chamber around the water outlet; the threaded structure is configured for connecting to a water hose.
